(19) United States
(12) Patent Application Publication
(10) Pub. No.: US 2007/0074943 A1
(43) Pub. Date: Apr. 5, 2007

(54) Clutch arrangements for a torque converter, torque converter for a dual-input gearbox, and methods thereof

(75) Inventors: Jeffrey Hemphill, Copley, OH (US); George Bailey, Wooster, OH (US); William Brees, Wooster, OH (US); Patrick Lindemann, Wooster, OH (US); Edmund Maucher, Wooster, OH (US); Christopher Shamie, Wadsworth, OH (US)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 11/513,710

(22) Filed: Aug. 31, 2006

Related U.S. Application Data
(60) Provisional application No. 60/714,019, filed on Sep. 2, 2005.

(51) Int. Cl. F16D 33/00

(52) U.S. Cl. 192/3.25

(57) ABSTRACT

The invention broadly comprises a torque converter with a pump clutch operatively arranged to couple a pump in the converter to a torsional input to the converter and a torque converter clutch operatively arranged to couple the torsional input to an output shaft for the converter. The pump clutch is arranged to maintain the coupling of the pump to the input as the torsional input and the shaft are coupled. The torque converter also includes at least one vibration damping means. The damping means is operatively connected to the torsional input and disposed in the converter such that the torsional input passes through the at least one vibration damping means when the input is coupled to the pump. The present invention also broadly comprises a torque transmitting apparatus, comprising a torque converter, a first input shaft for a dual-input gearbox, and, means for coupling the converter and the input shaft.

### CROSS-REFERENCE TO RELATED APPLICATIONS

This application claims the benefit under 35 U.S.C. §119(e) of U.S. Provisional Application No. 60/714,019, filed Sep. 2, 2005.

### FIELD OF THE INVENTION

The invention relates to improvements in apparatus for transmitting force between a rotary driving unit (such as the engine of a motor vehicle) and a rotary driven unit (such as the variable-speed transmission in the motor vehicle). In particular, the invention relates to a clutch assembly in a multi-function torque converter for coupling torsional input during idle, torque conversion, and lock-up modes. The clutch assembly also provides modulation of pump and turbine inertias. The invention also relates to a torque converter for use with a dual-input gearbox.

### BACKGROUND OF THE INVENTION

It is known to use a dual-mass configuration and a pump clutch to disconnect the pump in a multi-function torque converter from the engine when a vehicle is idling. Unfortunately, the performance of such torque converters under various modes of operation and vehicle operating conditions may not be consistent.

A powershift transmission, for example the Parallel Shift Gearbox, includes odd and even gears, and a double-clutch. Torque may be passed continuously from a first clutch and a second clutch each associated with the odd and even gears, respectively. The first and second clutches of the Parallel Shift Gearbox are currently either multi-plate wet clutches or dry clutches and are used to launch the vehicle and perform shifts between gears. The clutches are operatively arranged either one inside another or are aligned beside each other within the bell housing such that torque is transmitted to concentric dual-input shafts.

A problem with multi-plate wet clutches and dry clutches is that relatively large clutches must be utilized such that launch events and hill hold events are manageable. Further, wet clutches require a high-flow cooling system. In addition, the launch characteristics require many adjustments and are subject to variation as the clutch and fluid change over time and temperature.

What is needed then is a means to increase the performance of multi-function torque converters under various modes of operation and vehicle operating conditions. What is also needed is a Parallel Shift Gearbox clutch system operatively arranged inside the housing of a torque converter such that the weight and inertia of the clutch system required for creep, launch, hill hold, and stall conditions are reduced.

### BRIEF SUMMARY OF THE INVENTION

The invention broadly comprises a torque converter with a pump clutch and a torque converter clutch. The pump clutch is operatively arranged to couple a pump in the torque converter to a torsional input to the converter. The torque converter clutch is operatively arranged to couple the torsional input to an output shaft for the torque converter. The pump clutch is arranged to maintain the coupling of the pump to the input as the torsional input and the shaft are coupled. The torque converter also includes at least one vibration damping means. The damping means is operatively connected to the torsional input and disposed in the torque converter such that the torsional input passes through the at least one vibration damping means when the input is coupled to the pump.

In some aspects, the torque converter includes a flex plate connected to the torsional input and the at least one vibration damping means is disposed between the flex plate and the pump clutch. The torque converter further comprises a first reaction plate operatively connected to the at least one damping means, the pump clutch, and the torque converter clutch. The pump clutch and the torque converter clutch are arranged to couple the first plate to the pump and the shaft, respectively.

In some aspects, the torque converter includes at least one lug connecting the at least one vibration damping means to the flex plate and the at least one vibration damping means includes at least one spring. The at least one lug and the at least one spring are in same respective planes radially and axially with respect to a longitudinal axis for the stator and the at least one lug and the at least one spring are tangentially offset with respect to the axis. In some aspects, the torque converter includes a second reaction plate operatively connected to the at least one vibration damping means and the pump clutch. The pump clutch and the torque converter clutch are arranged such that the pump clutch couples the torsional input for the torque converter clutch.

In some aspects, the at least one vibration damping means is disposed between the pump clutch and the pump and the pump clutch and the torque converter clutch are arranged such that the pump clutch couples the torsional input for the torque converter clutch. In some aspects, the torque converter includes first and second fluid chambers in communication with the pump clutch and the torque converter clutch, respectively, and a grooved washer disposed between the first and second chambers and operatively arranged to enable fluid communication between the first and second chambers. In some aspects, the torque converter includes third and fourth fluid chambers in communication with the pump clutch and the torque converter clutch, respectively, and an intermediate plate disposed between the third and fourth chambers and operatively arranged to enable fluid communication between the third and fourth chambers.

The invention also broadly comprises a torque converter with a torque converter clutch and at least one means for transferring inertia from a pump in the torque converter. The torque converter clutch is operatively arranged to couple a torsional input for the torque converter to an output shaft for the torque converter and the means is arranged to transfer the inertia when the input and the shaft are coupled. In some aspects, the torque converter comprises core rings and the at least one means further comprises a Lanchester damper operatively connected to the core rings.

The invention also broadly comprises a torque transmitting apparatus including a torque converter, a first input shaft for a dual-input gearbox, and means for coupling the torque converter and the first input shaft. The apparatus also includes a turbine and a first piston connected to the first input shaft. The means for coupling include a first clutch operatively arranged to couple the first piston and the turbine. The apparatus receives a torsional input and further includes a second clutch and a flange plate connected to the torsional input. The second clutch is operatively arranged to couple the flange plate and the first piston. Further, the apparatus includes a second piston, a second input shaft, and a third clutch. The second piston is connected to the second input shaft. The third clutch is operatively arranged to couple the second piston and the flange plate.

The apparatus further comprises a vibration dampening means and a pump. The flange is connected to the vibration dampening means. The first clutch is operatively arranged to decouple the first piston and the turbine. The pump rotates at a first speed and the turbine rotates at a second speed. The first clutch decouples and the second clutch couples in response to a ratio of the first and second speeds. The apparatus also includes at least one fluid chamber and at least one valve operatively arranged to control respective fluid pressure in the at least one chamber. The at least one valve is selected from the group consisting of a centrifugally controlled valve and a conduit connecting valve. The first clutch operates responsive to the respective fluid pressure.

The invention also comprises a method for modulating inertial resistance to a torsional input for a torque converter.

The invention further comprises a method for increasing torque to a dual-input gearbox system.

One object of the present invention is to increase the performance of torque converters under various modes of operation and vehicle operating conditions.

Another object of the invention is to improve the fuel economy of a vehicle by decreasing engine speed for creep, launch, hill hold, and stall conditions.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a partial cross-sectional view of a present invention clutch arrangement with a three-pass design;

FIG. 1A is a perspective view of the lug and spring configuration shown in FIG. 1;

FIG. 1B is a cross-sectional view along line B-B in FIG. 1A;

FIG. 2 is a partial cross-sectional view of a present invention clutch arrangement with a three-pass design and dual clutches;

FIG. 2A is a perspective view of the grooved washer shown in FIG. 2;

FIG. 3 is a partial cross-sectional view of a present invention clutch arrangement with a three-pass design and a Lanchester damper;

FIG. 4 is a partial cross-sectional view of a present invention clutch arrangement with a two-pass design;

FIG. 5 is a partial cross-sectional view of a present invention clutch arrangement for a torque converter connected to a dual-input gearbox;

FIG. 6A shows the present invention clutch arrangement of FIG. 5 with the turbine clutch engaging the turbine;

FIG. 6B shows the present invention clutch arrangement of FIG. 5 with the turbine clutch disengaged from the turbine and the first friction clutch engaged;

FIG. 7A is an engine speed diagram depicting vehicle launch associated with a present invention clutch arrangement;

FIG. 7B is a torque diagram depicting vehicle launch associated with a present invention clutch arrangement; and,

FIG. 7C is a fuel rate diagram depicting vehicle launch associated with a present invention clutch arrangement.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

U.S. Pat. No. 6,494,303 (Reik et al.) “Torsional Vibration Damper For a Torque Transmitting Apparatus” is incorporated by reference herein. Reik discloses a torque converter having a torsional input connected to a vibration damper. The damper is connected to a pump clutch and a torque converter clutch. The pump clutch is arranged to couple a housing for the torque converter and a housing for a turbine in the converter. The torque converter clutch operates to couple the damper to the housing for a pump in the converter and an output shaft for the torque converter. During idle mode, both clutches operate so that the torque converter housing and the damper are disconnected from the pump and shaft. To begin torque converter mode, the pump clutch couples the pump and torque converter housings. To initiate lock-up mode, the pump clutch disengages the pump and converter housings and simultaneously, the torque converter clutch engages the damper with the pump housing and the shaft.

The figures that follow show particular combinations of components, particular configurations of those components, and means of connecting or interfacing the components. However, it should be understood that the present invention is not limited to the combinations, configurations, and connecting/interfacing means shown. Other combinations, configurations, and connecting/interfacing means, known in the art, can be used to implement the present invention and such modifications are within the spirit and scope of the claims.

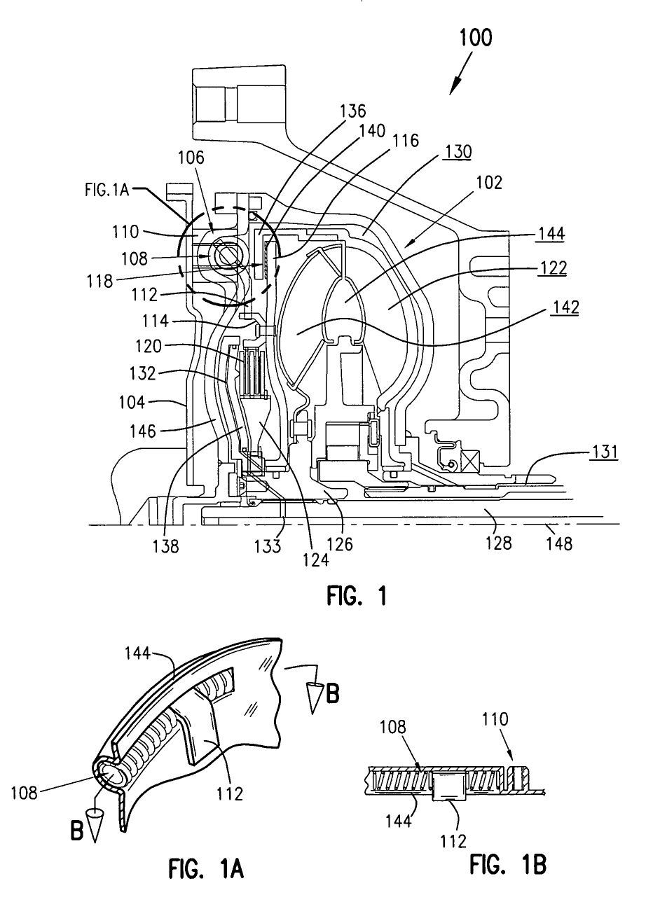

FIG. 1 is a partial cross-sectional view of present invention clutch arrangement 100 with a three-pass design. By three-pass design, we mean that three fluid circuits are used in the clutch arrangement. Torque converter 102 is connected to flex plate 104, which in turn is connected to a drive unit (not shown), such as an engine. The drive unit provides torsional input to flex plate 104. Torsional damper 106 includes coil springs 108 and is connected to plate 104 via lugs 110. Flange 112 is connected to spline 114, which in turn is connected to piston or reaction plate 116. Hereinafter, the terms piston and reaction plate are used interchangeably and refer to a structure that moves in reaction to fluid pressures in a torque converter. Pump clutch 118 and torque converter clutch 120 (via spline 114) are connected to piston 116. In some aspects, clutch 120 is a closed-piston type, which minimizes centrifugal pressure effects. Clutch 118 couples the torsional input, through piston 116, to pump 122. Clutch 120 is connected to plate 124, which is connected to hub 126. Hub 126, in turn, is connected to output shaft 128. Clutch 120 couples the torsional input to shaft 128.

In idle mode, fluid pressure in fluid channel or fluid chamber (the terms fluid channel and fluid chamber are used interchangeably hereinafter) 130 is increased via channel 131 and the fluid pressure in fluid channel 132 is decreased via orifice 133. The high pressure in channel 130 causes pump 122 to move axially toward the drive unit (right to left in FIG. 1), causing plate 136 to move away from piston 116, disengaging pump clutch 118. The low pressure in channel 132 causes plate 138 to remain disengaged from clutch 120. Therefore, both clutches are disengaged and neither pump 122 nor shaft 128 is engaged with the torsional output. Therefore, in idle mode, the load is reduced on the drive unit and the energy efficiency of the drive unit is improved.

To initiate operation of converter 102, pressure in channel 130 decreases, causing pump 122 to move axially toward the transmission (not shown) (left to right in FIG. 1). This movement causes clutch 118 to engage. That is, plate 136 moves left to right to engage piston 116. In FIG. 1, friction material 140 is shown on piston 116 and causes piston 116 and plate 136 to lockup. The aforementioned lockup results in torsional input being coupled to pump 122. It should be understood that friction material also could be placed on plate 136 or on both piston 116 and plate 136. In the descriptions that follow, friction material is shown in a certain configuration, and as described for material 140, it should be understood that other configurations are possible. In the interest of brevity, the preceding discussion regarding the location of friction materials is not repeated. Clutch 120 remains disengaged. Therefore, shaft 128 is driven by the fluid connection of pump 122 and turbine 142.

To initiate lockup mode, the pressure in channel 132 is increased via orifice 133, causing plate 138 to move left to right, which causes clutch 120 to engage. Engaged clutch 120 couples torsional energy from spline 114 to plate 124, which transfers the energy to shaft 128 as described supra. Clutch 118 remains engaged. The components of a torque converter accepting torsional input from a drive unit also experience a load, acting counter to the torsional input, due to the vehicle inertia. During the shift from converter mode to lockup mode if the pump is disengaged, the load can diminish too rapidly, causing the drive unit to undesirably race. However, during the shift from converter mode to lockup mode, clutch 118 advantageously remains engaged. That is, the pump inertia acts to stabilize the torsional input and improve torsional fluctuations. In some aspects, once the coupling of the torsional input and drive shaft is stabilized, clutch 118 is disengaged. These aspects are particularly advantageous when converter 102 is operating in the lockup mode at a low engine speed. At low speeds, a low resonance mode may be present and disengaging clutch 118 may shift the resonance. Pressure in chamber 144 is kept high in all modes.

FIG. 1A is a perspective view of the lug and spring configuration shown in FIG. 1.

FIG. 1B is a cross-sectional view along line B-B in FIG. 1A. The following should be viewed in light of FIGS. 1, 1A, and 1B. FIGS. 1A and 1B show the configuration of springs 108, lugs 110, flange 112, and cover 146. In FIG. 1, springs 108 and lugs 110 are in same respective radial and axial planes with respect to axis 148. In some aspects, and as shown in FIG. 1B, springs 108 and lugs 110 are tangentially offset, to remove potential interferences between the springs and lugs. The offset allows for a more efficient use of space, which is particularly valuable for torque converters or dampers in which space is a concern.

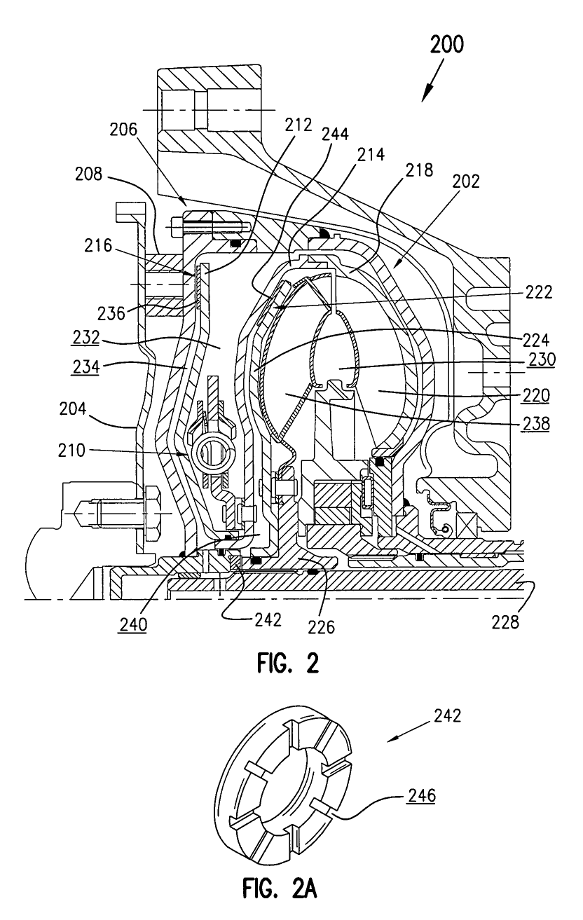

FIG. 2 is a partial cross-sectional view of present invention clutch arrangement 200 with a three-pass design and dual clutches. In some aspects, each clutch is a torque converter clutch. In some aspects, one clutch is a torque converter clutch and the other clutch is a pump clutch. Torque converter 202 is connected to flex plate 204, which in turn is connected to a drive unit (not shown), such as an engine. The drive unit provides torsional input to flex plate 204. Cover 206 is connected to plate 204 through lugs 208. Torsional damper 210 is connected to plate 212 and plate/intermediate cover 214. Pump clutch 216 is connected to plate 212, which is in turn connected to plate 214 through damper 210. Plate 214 is connected to housing 218 for pump 220. Clutch 216 couples the torsional input to pump 220. Torque converter clutch 222 is connected to plate 214 and plate 224. Plate 224 is connected to hub 226, which is connected to output shaft 228. Clutch 222 couples the torsional input to shaft 228.

In idle mode, fluid pressure in fluid channels 230, 232, and 234 are all kept high. These high pressures cause clutches 216 and 222 to disengage. Therefore, neither pump 220 nor shaft 228 is engaged with the torsional output. Therefore, in idle mode, the load is reduced on the drive unit and the energy efficiency of the drive unit is improved.

To initiate operation of converter 202, pressure in channel 230 is decreased as far as possible while avoiding cavitation in pump 220. Pressure in channel 232 is kept as high as possible. The pressure in channel 234 is kept higher than the pressure in 230, but lower than the pressure in channel 232. This configuration of pressures causes plate 212 to move toward cover 206, engaging clutch 216. In FIG. 2, friction material 236 is shown on plate 212 and causes plate 212 and cover 206 to lockup. The aforementioned lockup results in torsional input being transferred to pump 220. Clutch 222 remains disengaged. Therefore, shaft 228 is driven by the fluid connection of pump 220 and turbine 238.

Fluid channel 240 is in fluid communication with fluid channel 234 via grooved washer 242. To initiate lockup mode, the pressure in channel 240 is minimized, causing plates 214 and 224 to move together. This movement engages clutch 222. Engaged clutch 222 couples torsional energy from plate 214 to shaft 228 as described supra. Clutch 216 remains engaged.

Friction material 244 is shown on plate 224 and causes plates 214 and 224 to lockup. As noted supra, a drive unit connected to a torque converter can undesirably race during the shift from converter mode to lockup mode. However, during the shift from converter mode to lockup mode, clutch 216 remains engaged.

FIG. 2A is a perspective view of grooved washer 242 shown in FIG. 2. The following should be viewed in light of FIGS. 2 and 2A. Washer 242 includes grooves 246 that enable fluid communication between fluid channels 234 and 240. In some aspects (not shown), washer 242 is not grooved. Instead, plate 214 is slotted (not shown) to enable fluid communication between channels 232 and 240. Then, to operate in idle mode, pressures in channels 230, 232, and 234 are all kept high. To initiate converter mode, pressure in channel 234 is dropped, causing clutch 216 to engage. To initiate lockup mode, pressure in channel 232 is reduced to a medium level between the pressure in channel 230 and the pressure in channel 234. This configuration enables the pressure in channel 230 to remain high enough to avoid cavitation.

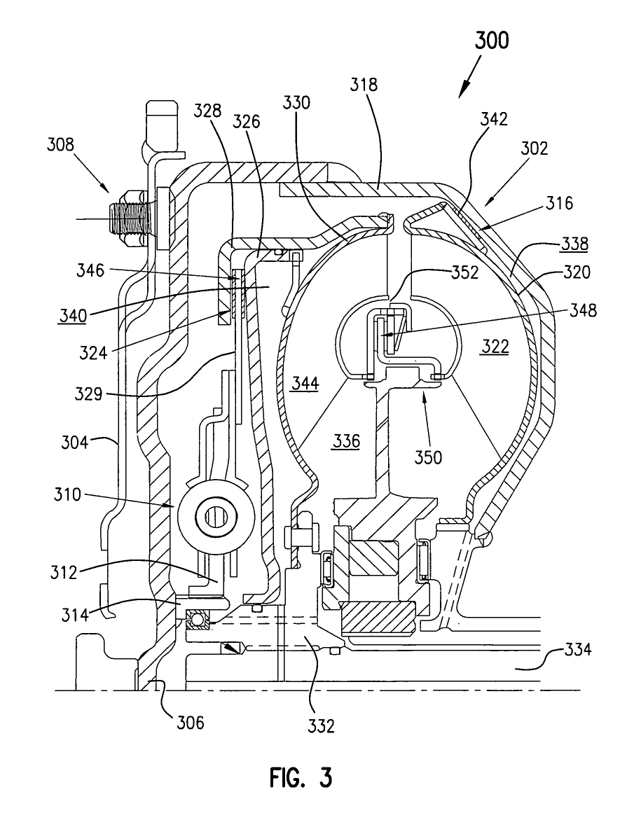

FIG. 3 is a partial cross-sectional view of present invention clutch arrangement 300 with a three-pass design and a Lanchester damper. Torque converter 302 is connected to flex plate 304, which in turn is connected to a drive unit (not shown), such as an engine. The drive unit provides torsional input to flex plate 304. Cover 306 is connected to plate 304 through a weld on bolt 308. Torsional damper 310 includes flange 312, connected to cover 306 through spline 314. Pump clutch 316 is connected to converter housing 318 and pump housing 320. Clutch 316 couples the torsional input to pump 322. Torque converter clutch 324 is connected to piston 326, plate 328, and plate 329. Plate 329 is connected to damper 310. Plate 326 is connected to turbine housing 330, which is connected to hub 332. Hub 332 is connected to output shaft 334. Clutch 324 couples the torsional input to shaft 334. In some aspects, clutch 324 is a closed-piston type clutch. A closed-piston type clutch is less susceptible to centrifugal pressure effects.

In idle mode, fluid pressure in channels 336 and 338 is increased and the pressure in channel 340 is kept low. These pressures cause clutches 316 and 324 to disengage. Therefore, neither pump 322 nor shaft 334 is engaged with the torsional output. Therefore, in idle mode, the load is reduced on the drive unit and the energy efficiency of the drive unit is improved.

To initiate operation of converter 302, pressure in channels 338 and 340 are kept as low as possible and the pressure in channel 336 is increased. This configuration of pressures causes pump 322 to move axially toward the transmission (not shown) (left to right in FIG. 3), engaging clutch 316. In FIG. 3, friction material 342 is shown on housing 320 and causes housing 318 and 320 to lockup. The aforementioned lockup results in torsional input being coupled to pump 322. Clutch 324 remains disengaged. Therefore, shaft 334 is driven by the fluid connection of pump 322 and turbine 344.

To initiate lockup mode, the pressure in channel 336 is decreased and the pressure in channels 338 and 340 is increased. The pressure in channel 340 is raised higher than the pressure in channel 338. These pressures engage clutch 324. The pressure in chamber 336 is the minimum pressure required to prevent cavitation in the torque converter. The pressure in chamber 338 is the minimum pressure required to provide sufficient cooling flow. The pressure in chamber 340 is the minimum pressure required to achieve required clutch 324 capacity. Engaged clutch 324 couples torsional energy from plate 329 to shaft 334 as described supra. Friction material 346 is shown on plate 329 and causes plates 328 and 329 and piston 326 to lockup.

A dual-mass torque converter can be used to reduce driveline torsional fluctuations. Therefore, damper 348 is located in the core rings 350 of converter 302 and acts to transfer inertia from pump 322 to the turbine 344 during lockup mode. In some aspects, damper 348 is a Lanchester damper. During converter mode, the torque in converter 302 exceeds the torque capacity of damper 348 causing the damper to slip. However, since damper 348 has a relatively low torque capacity, this slippage has a nominal impact on the performance of converter 302. During lockup mode, when torsional fluctuations coming through converter 302 are low (less than the torsional capacity of damper 348), damper 348 locks the pump and the turbine together, providing the functionality of a dual mass torque converter.

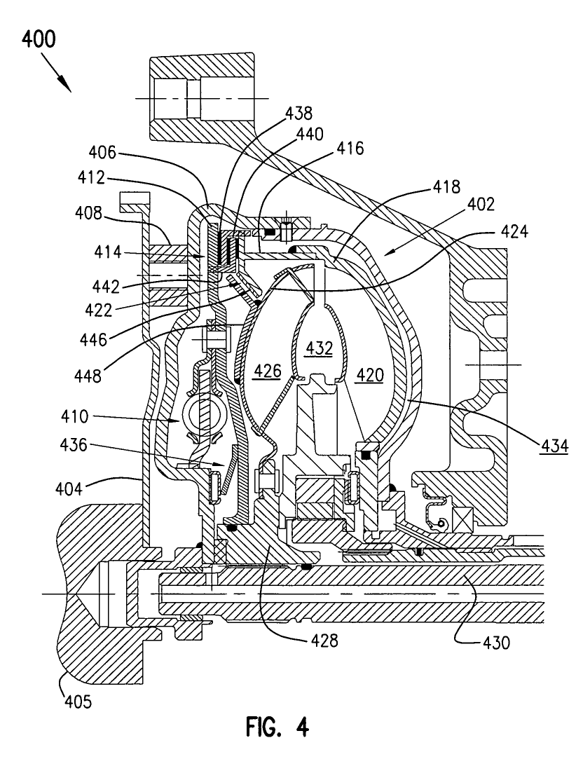

FIG. 4 is a partial cross-sectional view of present invention clutch arrangement 400 with a two-pass design. By two-pass design, we mean that two fluid circuits are used. Torque converter 402 is connected to flex plate 404, which in turn is connected to drive unit 405 (partially shown), such as an engine. The drive unit provides torsional input to flex plate 404. Cover 406 is connected to plate 404 through lugs 408. Torsional damper 410 is connected to cover 406 and piston 412. Pump clutch 414 is connected to piston 412 and plate 416. Plate 416 is connected to housing 418 for pump 420. Clutch 414 couples the torsional input to pump 420. Torque converter clutch 422 is connected to plate 416 and housing 424 for turbine 426. Housing 424 is connected to hub 428, which is connected to output shaft 430. Clutches 414 and 422 couple the torsional input to shaft 430.

In idle mode, fluid pressure in fluid chamber 432 is kept high and fluid pressure in chamber 434 is kept low. These pressures cause pump 420 to move axially toward the transmission (not shown) (left to right in FIG. 4), releasing clutches 414 and 422. Therefore, neither pump 420 nor shaft 430 is engaged with the torsional input. Therefore, in idle mode, the load is reduced on the drive unit and the energy efficiency of the drive unit is improved. In idle mode, diaphragm spring 436 causes plate 412 to move axially toward the transmission.

To initiate operation of converter 402, pressure in chamber 432 is brought low and the pressure in chamber 434 is brought to a medium value. As a result, pump 420 moves axially toward the drive unit (right to left in FIG. 4) and clutch 414 engages. The axial force due to the differential pressure on pump 420 is reacted through plate 412 via spring 436. -The spring deflects sufficiently to enable clutch 414 to engage, but not sufficiently to enable clutch 422 to engage. In FIG. 4, friction materials 438 on plates 440 and 442 cause plates 412 and 416 to lockup. The aforementioned lockup results in torsional input being transferred to pump 420. Clutch 422 remains disengaged. Therefore, shaft 430 is driven by the fluid connection of pump 420 and turbine 426.

To initiate lockup mode, the pressure in channel 434 is increased to a maximum value, causing pump 420 to axially move further toward the drive unit. The increased force due to the differential pressure across pump 420 is transferred to plate 412 by clutch 414 and causes spring 436 to deflect further. As a result, plate 412 moves further toward the drive unit engaging clutch 422. Engaged clutch 422 couples torsional energy from plate 412 to shaft 430 as described supra. Clutch 414 remains engaged. Friction material 446 on plate 416 causes plates 416 and 448 to lockup. As noted supra, a drive unit connected to a torque converter can undesirably race during the shift from converter mode to lockup mode. However, during the shift from converter mode to lockup mode, housing 406 remains connected to housing 418, transferring inertia from pump 420 to housing 424.

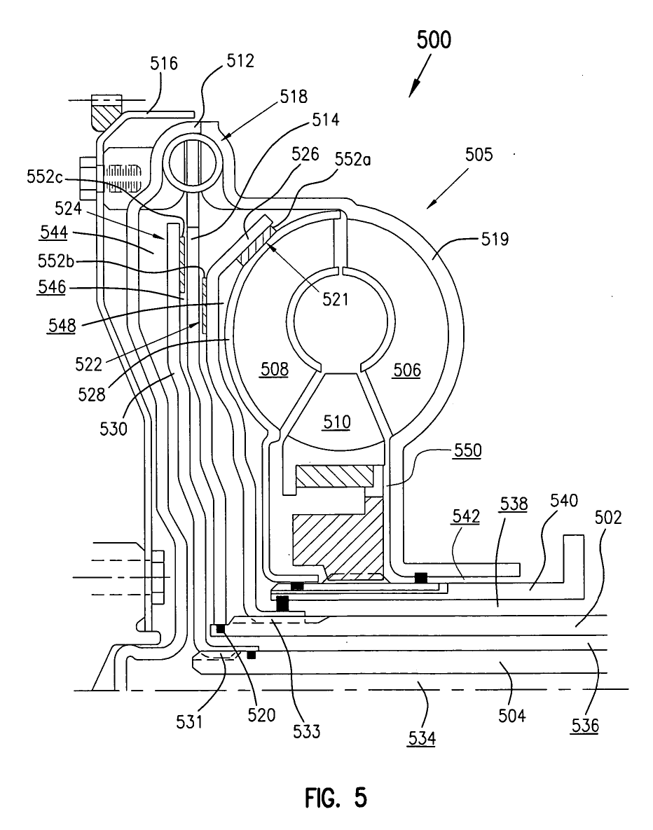

FIG. 5 is a partial cross-sectional view of present invention clutch arrangement 500 for a torque converter connected to a dual-input gearbox. By dual-input gearbox, it is meant that the power train is a manual shift transmission comprising a first input shaft 502 and a second input shaft 504 connected to odd and even gears (not shown), respectively. Input shafts 502 and 504 are concentric. Hereinafter input shafts 502 and 504 are referred to as an odd gear input shaft and even input shaft, respectively. By “odd gear input shaft” it is meant that a first input shaft is connected to odd gears one, three, and five etc. in the power train. Further, by “even gear input shaft,” it is meant that a second input shaft is connected to even gears two, four, and six etc. in the power train. However, it should be apparent that odd and even gear input shafts can be connected to a plurality of gears located within the power train.

Present invention 500 comprises means for coupling torque converter 505 to odd gear input shaft 502. Torque converter 505 generally comprises pump 506, turbine 508, stator 510 disposed between pump 506 and turbine 508, and plate 512. Plate 512 is disposed between flange plate 514 and flex plate 516. Plate 516 is attached to a drive unit (not shown), such as an internal combustion engine via an output shaft (not shown). Flange plate 514 is connected to vibration-dampener 518. Flex plate 516 is connected to plate 512, which is connected to torque converter housing 519 such that the housing rotates with flex plate 516. The torsional input from the drive unit is transmitted from flex plate 516 to plate 512, enters vibration-dampener 518, and is then carried into flange plate 514. Flange plate 514 is received on odd gear input shaft 502 and is sealingly engaged with odd gear input shaft 502 by means of sealing ring 520.

Arrangement 500 includes turbine clutch 521 and friction clutches 522 and 524. It should be appreciated that turbine clutch 521 is also known as a friction clutch. Friction clutch 522 is disposed between flange plate 514 and piston 526. Clutch 522 is operatively arranged to couple flange plate 514 and piston 526 such that torsional input received by flange plate 514 is transmitted from flange plate 514 to odd gear input shaft 502 via piston 526. Piston 526 is disposed between turbine shell 528 and flange plate 514. Friction clutch 524 is disposed between piston 530 and flange plate 514. Clutch 524 is operatively arranged to couple flange plate 514 and piston 530 such that torsional input received by flange plate 514 is transmitted from flange plate 514 to even gear input shaft 504 via piston 530. Piston 530 is received on even gear input shaft 504 and is engaged with even gear input shaft 504 by means of spline 531. Piston 530 is also sealingly engaged with even gear input shaft 504 by means of a sealing ring (not shown).

In some aspects, means for coupling and decoupling piston 526 and turbine 508 comprises turbine clutch 521. Piston 526 is received on odd gear input shaft 502 and is engaged with odd gear input shaft 502 by means of spline 533. As described in more detail infra, friction clutches 522 and 524, and turbine clutch 521 are engaged via controlled hydraulic pressure changes of a pressurized medium supplied through conduit 534 located in the hollow of even gear input shaft 504, though conduit 536 located between odd gear input shaft 502 and even gear input shaft 504, through conduit 538 located between stator shaft 540 and odd gear input shaft 502, and/or through conduit 542 located between stator shaft 540 and housing 519. Conduit 534 is an inlet port. By “inlet port,” we mean that medium flows from transmission sump (not shown) to conduit 534. Conduits 534, 536, 538, and 542 have corresponding fluid chambers 544, 546, 548, 550. Pressure in conduit 534 and corresponding chamber 544 is always high. Conduits 536, 538, and 542 are outlet ports. By “outlet port”, we mean that medium flows through conduits 536, 538, and 542 back to the transmission sump (not shown). Pressure in conduits 536, 538, and 542 is controlled via valves (not shown). An example of a pressurized medium that can be used is high-pressure oil. It should be appreciated, however, that other high-pressure mediums can be used and these modifications are intended to be within the spirit and scope of the invention as claimed. Friction materials 552a, 552b, and 552c are attached to piston 526, piston 526, and plate 530, respectively.

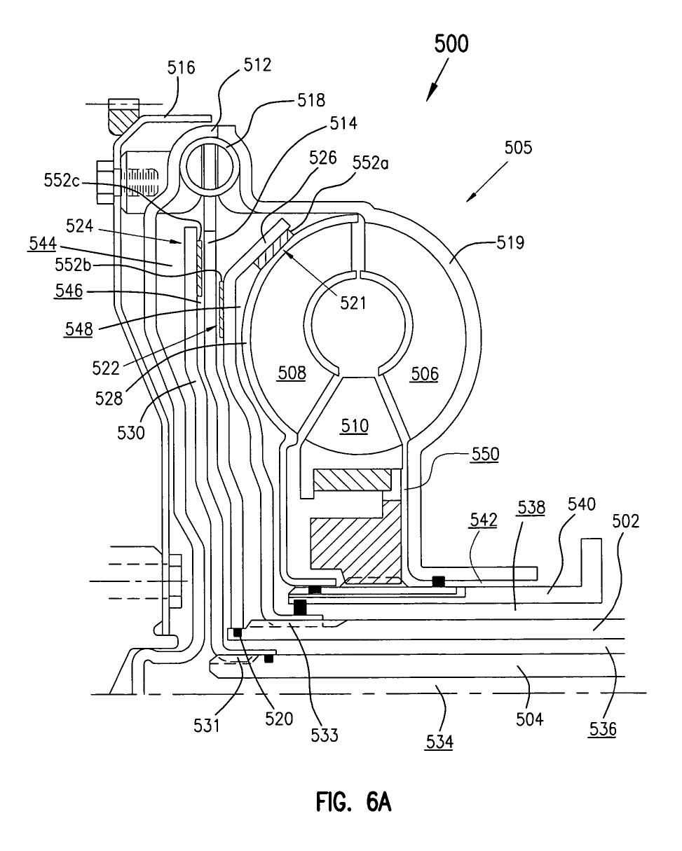

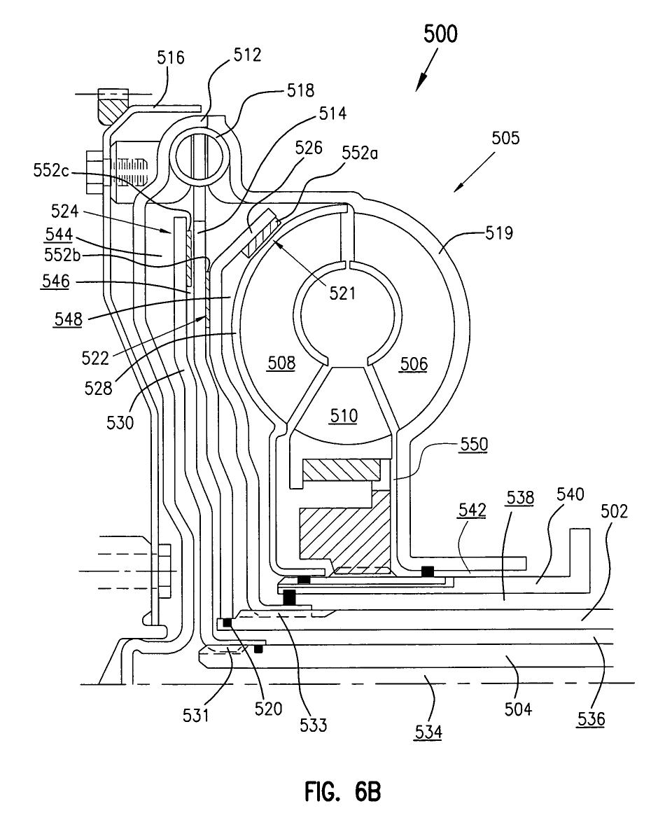

FIG. 6A shows the present invention clutch arrangement 500 of FIG. 5 with 20 turbine clutch 521 engaging turbine 508. In an idle disconnect mode, all three outlet port valves of conduits 536, 538, and 542 are closed so that oil cannot leave converter 505. To engage the turbine clutch for creep and launch in torque converter mode, a brake petal for the vehicle is released (not shown) and valve for conduit 542 opens allowing oil to flow to sump. Therefore, pressure in conduit 542 and corresponding fluid chamber 550 is low. Valves for conduits 536 25 and 538 remain closed, maintaining high pressure in corresponding fluid chambers 546 and 548, respectively. Pressure in conduit 534 and corresponding fluid chamber 544 is always high. It should be appreciated that piston 526 is grooved in order to flow cooling oil at a rate of approximately 2-3 liters/minute during the torque converter mode. High pressure in conduits 534, 536, and 538 causes piston 526 to shift axially toward turbine 508 such that turbine clutch 521 is engaged with turbine 508 via turbine shell 528. Thus, creep torque begins to build and torque from turbine 508 increases, beginning the creep and launch event of the vehicle. By “creep and launch event,” we mean the vehicle initiates motion from a stopped position. It should be appreciated by those having ordinary skill in the art that torque converter 505 provides torque multiplication. This torque multiplication is utilized for creep, launch, hill hold and stall conditions. When a ratio of engine speed to turbine speed exceeds a predetermined ratio, friction clutch 522, coupled to odd gear input shaft 502, is engaged. In some aspects, the predetermined ratio is about 0.5. That is, turbine 508 rotates at the speed of the power train and at half the speed of pump 506, which rotates at the speed of the drive unit. Thus, since torque converter 505 provides torque multiplication, a lower first gear ratio is required to achieve a smooth and quick transition during the launch event. Further, the torque multiplication reduces the center distance required in a power train such that the weight and cost of the power train can be reduced.

FIG. 6B shows the present invention clutch arrangement 500 of FIG. 5 with turbine clutch 521 disengaged from turbine 508 and clutch 522 engaged. To engage friction clutch 522, while turbine clutch 521 is still engaged, the torque in friction clutch 522 slowly increases until it is fully locked at the end of the launch event. By “slowly increases,” it is meant that the torque in friction clutch 522 is increased over a period of time of at least 1.5 seconds until friction clutch 522 achieves the speed of the turbine. At this point, turbine clutch 521 is disengaged. More specifically, to engage friction clutch 522, valve for conduit 534 remains closed and therefore, pressure in conduit 534 remains high. Valves for conduits 538 and 542 open so that oil flows to the sump and pressure in conduits 538 and 542 and corresponding fluid chambers 548 and 550, respectively is low. Piston 526 is axially shifted away from turbine 508 and toward flange plate 514 such that odd gear input shaft 502 and turbine 508 are disconnected and piston 526 and flange plate 514 are clamped together. Thus, when clutch 522 is engaged, torque is transmitted to odd gear input shaft 502. The synchronization of sequential gear shifting between a first gear (not shown) associated with odd gear input shaft 502 and a second gear (not shown) associated with even gear input shaft 504 is enabled via friction clutches 522 and 524, respectively, such that shifting is comparable to that of an automatic power train. In some aspects, turbine clutch 521 is engaged via a centrifugally controlled valve (not shown) located on turbine shell 528. In some aspects, turbine clutch 521 is engaged via a valve (not shown) connected to conduit 538.

To engage friction clutch 524 and disengage clutch 522, valves for conduit 538 and conduit 542 are closed providing high pressure in corresponding fluid chambers 548 and 550, respectively. Valve for conduit 536 is open such that fluid flows to sump (not shown) and pressure is low in conduit 548. Therefore, piston plate 530 is shifted axially toward flange plate 514 causing piston plate 530 and flange plate 514 to be clamped together. Thus, when clutch 524 is engaged, torque is transmitted to even gear input shaft 504.

To reengage clutch 522 and disengage clutch 524, valves for conduits 536 and 542 are closed providing high pressure in conduits 536 and 542 and corresponding fluid chambers 546 and 550. Valve for conduit 538 is open such that fluid flows to sump and pressure in conduit 538 and fluid chamber 548 is low.

It should also be appreciated by those having ordinary skill in the art that clutches other than friction clutches can be used, such as multi-plate clutches and closed piston clutches, and separate dampers can be used in the torque path to each input shaft and these modifications are intended to be within the spirit and scope of the invention as claimed. Also, it should be apparent that a Dual Mass Flywheel damper can be integrated with the torque converter cover. Further, existing flex plates can be used thereby reducing a manufacturer's costs.

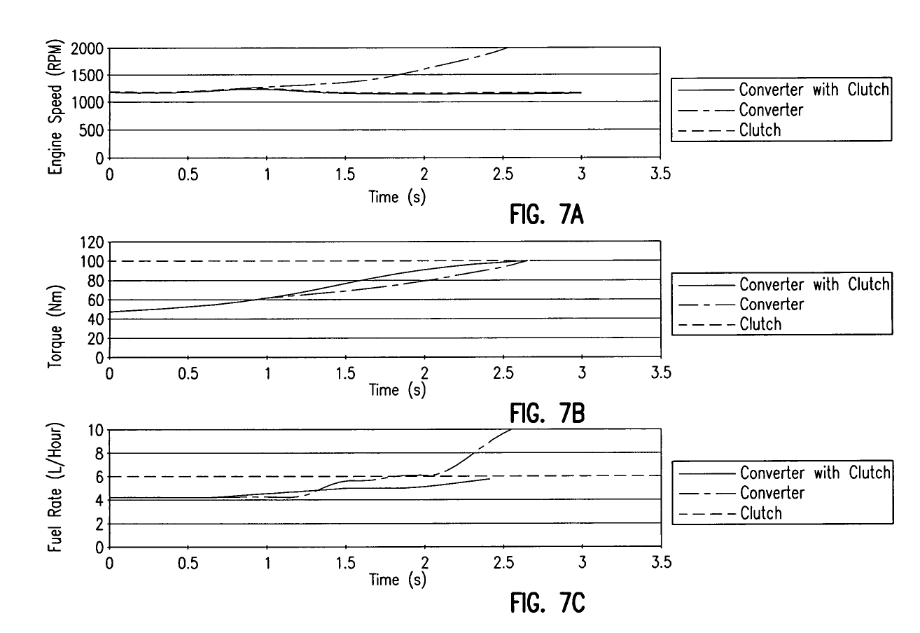

FIG. 7A is an engine speed diagram depicting vehicle launch associated with a present invention clutch arrangement 500. In the first three seconds of a launch event, less engine speed is required for clutch arrangement 500 than for a power train coupled to a converter without a clutch arrangement. The engine speed required for clutch arrangement 500 requires similar engine speed as a power train coupled to a clutch only system. For example, at two seconds, the engine speed required for clutch arrangement 500 and for a clutch only system is about 1300 rpm, while the engine speed required for a torque converter without a clutch arrangement requires an engine speed of about 1600 rpm.

FIG. 7B is a torque diagram depicting vehicle launch associated with a present invention clutch arrangement 500. Even though less engine speed is required for clutch arrangement 500 as compared to a power train having a torque converter without a clutch arrangement, a greater amount of torque is provided as compared to a torque converter without a clutch arrangement. For example, at two seconds, clutch arrangement 500 provides about 90 Nm of torque, while a torque converter without a clutch arrangement only provides about 80 Nm of torque. Since utilizing a torque converter with a clutch arrangement for a dual-input gearbox provides torque multiplication, unlike friction launch systems, including wet clutches, hill hold is provided indefinitely. It should be appreciated that the launch characteristics, such as the decrease in engine speed required and the increase in torque provided by clutch arrangement 500, are reproducible at all temperatures and conditions.

FIG. 7C is a fuel rate diagram depicting vehicle launch associated with a present invention clutch arrangement 500. The Fuel Rate graph shows a plot of a launch with clutch arrangement 500 as compared to a clutch only launch and a torque converter without a clutch arrangement launch. The plot shows that the efficiency of clutch arrangement 500 during a launch event is significantly higher than that of a clutch only launch and than that of a toque converter without a clutch arrangement. This provides a total fuel savings of approximately 1% on the EPA city cycle. It should be apparent that clutch arrangement 500, can be disconnected completely from the engine when the vehicle is idling (idle disconnect mode), thereby eliminating the traditional loss of efficiency typically associated with torque converters.

Another advantage of having clutch arrangement 500 for a dual-input gearbox having a clutch system within the torque converter housing is that the torus size of the torque converter may be reduced as compared to a normal torque converter, since friction clutch 522 will be used in all cases to increase torque capacity. Further, the amount of mass and inertia required are reduced. The cover of the torque converter serves as the primary inertia, and therefore, no wet or dry space is required. Further, all steel is available as a heat reservoir and maximum use of the material is made. Also, the clutches are greatly reduced in size since the torque converter handles the launch and engine stall events, which usually requires the most severe clutching sizing requirements.

Thus, it is seen that the objects of the invention are efficiently obtained, although modifications and changes to the invention may be readily imagined by those having ordinary skill in the art, and these changes and modifications are intended to be within the scope of the claims.

What we claim is:

1. A torque converter, comprising:
a pump clutch operatively arranged to couple a pump in said torque converter to a torsional input to said converter; and,
a torque converter clutch operatively arranged to couple said torsional input to an output shaft for said torque converter, where said pump clutch is arranged to maintain said coupling of said pump to said input as said torsional input and said shaft are coupled.

2. The torque converter of claim 1 further comprising:
at least one vibration damping means operatively connected to said torsional input, said at least one vibration damping means disposed in said torque converter such that said torsional input passes through said at least one vibration damping means when said input is coupled to said pump.

3. The torque converter of claim 2 wherein said torque converter further comprises a flex plate, said torsional input is connected to said flex plate, and said at least one vibration damping means is disposed between said flex plate and said pump clutch.

4. The torque converter of claim 3 further comprising:
a reaction plate operatively connected to said at least one vibration damping means, said pump clutch, and said torque converter clutch, where said pump clutch and said torque converter clutch are arranged to couple said reaction plate to said pump and said shaft, respectively.

5. The torque converter of claim 4 further comprising:
at least one lug connecting said at least one vibration damping means to said flex plate; and, wherein said at least one vibration damping means further comprises at least one spring, wherein said at least one lug and said at least one spring are in same respective planes radially and axially with respect to a longitudinal axis for said torque converter, and wherein said at least one lug and said at least one spring are tangentially offset with respect to said axis.

6. The torque converter of claim 4 wherein said pump clutch is a hook-type clutch and said torque converter clutch is a triple-plate clutch.

7. The torque converter of claim 3 wherein said pump clutch and said torque converter clutch are connected to said pump.

8. The torque converter of claim 7 wherein said pump clutch and said torque converter clutch are arranged such that said pump clutch couples said torsional input for said torque converter clutch.

9. The torque converter of claim 2 wherein said at least one vibration damping means is disposed between said pump clutch and said pump.

10. The torque converter of claim 9 wherein said pump clutch and said torque converter clutch are arranged such that said pump clutch couples said torsional input for said torque converter clutch.

11. The torque converter of claim 9 further comprising:
first and second fluid chambers in communication with said pump clutch and said torque converter clutch, respectively; and,
a grooved washer disposed between said first and second chambers and operatively arranged to enable fluid communication between said first and second chambers.

12. The torque converter of claim 9 further comprising:
third and fourth fluid chambers in communication with said pump clutch and said torque converter clutch, respectively; and,
an intermediate plate disposed between said third and fourth chambers and operatively arranged to enable fluid communication between said third and fourth chambers.

13. A torque converter, comprising:
at least one means for transferring inertia from a pump in said torque converter; and,
a torque converter clutch, where said torque converter clutch is operatively arranged to couple a torsional input for said torque converter to an output shaft for said torque converter and where said means is arranged to transfer said inertia when said input and said shaft are coupled.

14. The torque converter of claim 12 wherein said torque converter comprises core rings and said at least one means further comprises a Lanchester damper operatively connected to said core rings.

15. A method for modulating inertial resistance to a torsional input for a torque converter, comprising:
coupling a torsional input for a torque converter to a pump for said torque converter; and, coupling said torsional input to an output shaft for said torque converter while maintaining said coupling of said input and said pump.

16. The method recited in claim 15 further comprising:
dampening said torsional input before said input reaches said pump.

17. The method recited in claim 16 wherein said torque converter further comprises a reaction plate, wherein dampening said torsional input further comprises connecting said reaction plate to said torsional input, wherein coupling a torsional input to a pump further comprises coupling said reaction plate to said pump, and wherein coupling said torsional input to an output shaft further comprises coupling said reaction plate to said shaft.

18. The method recited in claim 16 wherein said torque converter further comprises at least one lug connected to at least one spring and further comprises a longitudinal axis; and, wherein dampening said torsional input further comprises:
disposing said at least one lug and said at least one spring in same respective planes radially and axially with respect to said axis; and,
tangentially offsetting said at least one lug and said at least one spring.

19. A torque transmitting apparatus, comprising:
a torque converter;
a first input shaft for a dual-input gearbox; and,
means for coupling said torque converter and said first input shaft.

20. The apparatus of claim 19 wherein said apparatus further comprises a turbine and a first piston connected to said first input shaft and wherein said means for coupling further comprises a first clutch operatively arranged to couple said first piston and said turbine.

21. The apparatus of claim 20 wherein said apparatus receives a torsional input and further comprises a second clutch and a flange plate connected to said torsional input, and wherein said second clutch is operatively arranged to couple said flange plate and said first piston.

22. The apparatus of claim 21 wherein said apparatus further comprises a second piston, a second input shaft, and a third clutch, wherein said second piston is connected to said second input shaft, and wherein said third clutch is operatively arranged to couple said second piston and said flange plate.

23. The apparatus of claim 21 wherein said apparatus further comprises a vibration dampening means and said flange plate is connected to said vibration dampening means.

24. The apparatus of claim 21 wherein said torque converter further comprises a pump, said pump rotating at a first speed, wherein said turbine rotates at a second speed, and wherein said first clutch is arranged to decouple in response to a ratio of said first and second speeds and said second clutch is arranged to couple in response to said ratio.

25. The apparatus of claim 21 wherein said apparatus further comprises at least one fluid chamber and at least one valve operatively arranged to control respective fluid pressure in said at least one chamber, wherein said at least one valve is selected from the group consisting of a centrifugally controlled valve and a conduit connecting valve, and wherein said first clutch operates responsive to said respective fluid pressure.

26. A method for increasing torque to a dual-input gearbox system comprising:
generating torque in a torque converter disposed in said system; and,
transmitting said torque to a first input shaft for a dual-input gearbox in said system.

27. The method recited in claim 26 wherein said system further comprises a first clutch and wherein transmitting said torque further comprises coupling said torque converter and said first input shaft using said first clutch.

28. The apparatus of claim 27 wherein said torque converter further comprises a pump and a turbine rotating at first and second speeds, respectively; and, said method further comprising:
decoupling said torque converter and said first input shaft using said first clutch in response to a ratio of said first and second speeds.

29. The method recited in claim 26 wherein said system further comprises a second clutch; and,
said further comprising:
connecting said system to a torsional input; and,
transmitting said torsional input to said first input shaft using said second clutch.

30. The method recited in claim 29 wherein said system further comprises a vibration dampening means and wherein transmitting said torsional input further comprises transmitting said input through said vibration dampening means.
